(19) United States
(12) Patent Application Publication
(10) Pub. No.: US 2012/0163280 A1
(43) Pub. Date: Jun. 28, 2012

(54) PHYSICAL LAYER COMMUNICATION PROTOCOL FOR USE IN WIRELESS NETWORKS WITH RELAYS

(76) Inventors: ALEXANDER MALTSEV, Nizhny Novgorod (RU); ALEXEI DAVYDOV, Nizhny Novgorod (RU); VADIM SERGEYEV, Nizhny Novgorod (RU); ANDREY CHERVYAKOV, Nizhny Novgorod (RU); ALEXEY KHORYAEV, Dzerzhinsk (RU)

(21) Appl. No.: 12/976,645

(22) Filed: Dec. 22, 2010

(51) Int. Cl. H04B 7/14

(52) U.S. Cl. 370/315

(57) ABSTRACT

In some embodiments, a relay station comprises a baseband processor, an RF modulator/demodulator coupled to the baseband processor to modulate/demodulate data for communication within a predetermined frequency range, and a control module to implement a femto transmission-free zone in at least one of a time domain or a frequency domain and in which the relay station does not transmit data. Other embodiments may be described.

### BACKGROUND

The phrase relay station (RS) in wireless networks commonly refers to adjunct, or supplemental, network nodes in a wireless network. In some applications relay stations may serve as a network access point for wireless devices. In other embodiments relay stations may function only to forward and/or amplify communication signals. Relay stations may be deployed in wireless to enhance wireless service coverage and/or performance in a wireless wide area network (WWAN). Relay stations may be deployed in buildings or other locations, such as at the edge of a network cell, in which performance of the wireless wide area network is degraded. Relay stations may be backhauled to the network via a broadband connection to the network, for example via a cable, fiber, wireless link, and/or digital subscriber line, such that a client device connects to the network via the locally disposed relay station rather than via a remotely disposed base station (BS) or a base transceiver station (BTS) of the network.

Relay stations may implement wireless communication links between a base station (BS) and one or more mobile subscribers (MS). Accordingly, techniques to reduce interference between relay stations and network base stations may find utility.

### BRIEF DESCRIPTION OF THE DRAWINGS

The detailed description is described with reference to the accompanying figures.

FIGS. 1A and 1B are a schematic illustration of a wireless wide area network, according to some embodiments.

FIG. 2 is a schematic illustration of a wireless networking station, according to some embodiments.

FIG. 3 is a flow diagram illustrating operations in a method to manage transmission power of a relay station, according to some embodiments.

FIG. 4 is a schematic illustration of a frame structure suitable for use in communication between a base station and a relay station, according to embodiments.

FIG. 5 is a flow diagram illustrating operations in a method to manage interference generated by a relay station, according to some embodiments.

FIGS. 6-10 are schematic illustrations of frame structures suitable for use in communication between a base station and a relay station, according to embodiments.

### DETAILED DESCRIPTION

Described herein are exemplary methods to manage data transmission between base stations and relay stations and embodiments of base stations and relay stations which implements such methods. In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. For example, “coupled” may mean that two or more elements do not contact each other but are indirectly joined together via another element or intermediate elements. Finally, the terms “on,” “overlaying,” and “over” may be used in the following description and claims. “On,” “overlying,” and “over” may be used to indicate that two or more elements are in direct physical contact with each other. However, “over” may also mean that two or more elements are not in direct contact with each other. For example, “over” may mean that one element is above another element but not contact each other and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect. In the following description and/or claims, the terms “comprise” and “include,” along with their derivatives, may be used and are intended as synonyms for each other.

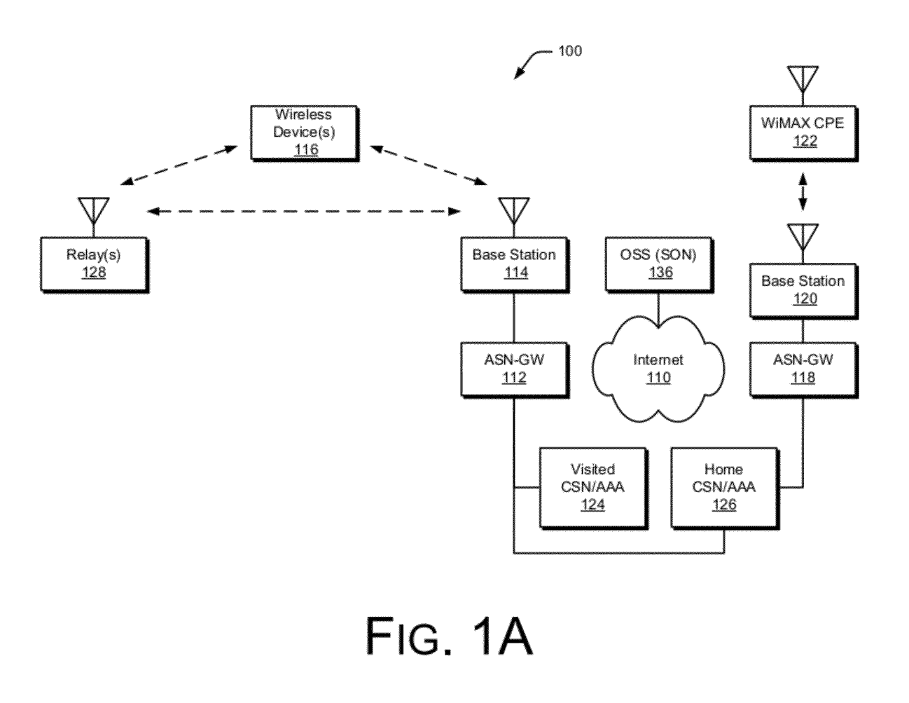

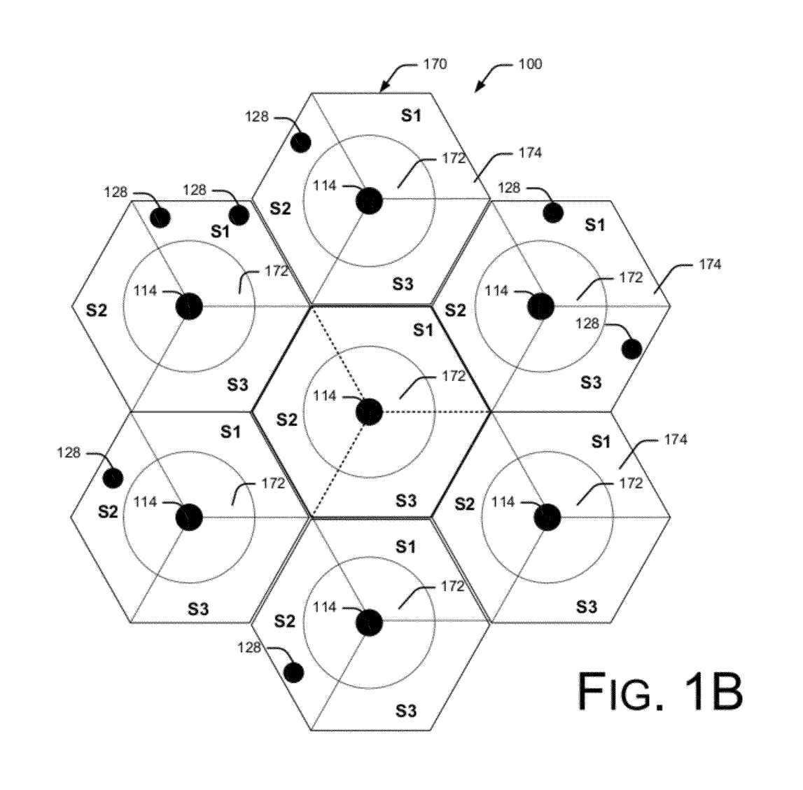

FIGS. 1A and 1B are a schematic illustration of a wireless wide area network, according to some embodiments. Referring now to FIG. 1, a block diagram of a wireless wide area network in accordance with one or more embodiments will be discussed. As shown in FIG. 1, network 100 may be an internet protocol (IP) type network comprising an Internet 110 type network or the like that is capable of supporting mobile wireless access and/or fixed wireless access to internet 110. In one or more embodiments, network 100 may be in compliance with a Worldwide Interoperability for Microwave Access (WiMAX) standard or future generations of WiMAX, and in one particular embodiment may be in compliance with an Institute for Electrical and Electronics Engineers 802.16 standard (IEEE 802.16-2009). In one or more alternative embodiments network 100 may be in compliance with a Third Generation Partnership Project Long Term Evolution (3GPP LTE) or a 3GPP2 Air Interface Evolution (3GPP2 AIE) standard, and/or a future generation cellular broadband network standard. In general, network 100 may comprise any type of orthogonal frequency division multiple access (OFDMA) based wireless network, and the scope of the claimed subject matter is not limited in these respects. As an example of mobile wireless access, access service network gateway (ASN-GW) 112 is capable of coupling with base station (BS) 114 to provide wireless communication between wireless device (SS) 116 and Internet 110. Wireless device 116 may comprise a mobile type device or information handling system capable of wirelessly communicating via network 100, for example a notebook type computer, a cellular telephone, a personal digital assistant, or the like. ASN-GW 112 may implement profiles that are capable of defining the mapping of network functions to one or more physical entities on network 100. Base station 114 may comprise radio equipment to provide radio-frequency (RF) communication with wireless device 116, and may comprise, for example, the physical layer (PHY) and media access control (MAC) layer equipment in compliance with an IEEE 802.16-2009 type standard. Alternatively, base station 112 may also be referred to as a base transceiver station (BTS) in one or more embodiments. Base station 114 may further comprise an IP backplane to couple to Internet 110 via ASN-GW 112, although the scope of the claimed subject matter is not limited in these respects.

Network 100 may further comprise a visited connectivity service network/authentication, authorization, and accounting (CSN/AAA) server 124 capable of providing one or more network functions including but not limited to proxy and/or relay type functions, for example authentication, authorization and accounting (AAA) functions, dynamic host configuration protocol (DHCP) functions, or domain name service controls or the like, domain gateways such as public switched telephone network (PSTN) gateways or voice over internet protocol (VOIP) gateways, and/or internet protocol (IP) type server functions, or the like. However, these are merely example of the types of functions that are capable of being provided by visited CSN/AAA or home CSN/AAA 126, and the scope of the claimed subject matter is not limited in these respects. Visited CSN/AAA 124 may be referred to as a visited CSN/AAA in the case for example where visited CSN/AAA 124 is not part of the regular service provider of wireless device 116, for example where wireless device 116 is roaming away from its home CSN/AAA such as home CSN/AAA 126, or for example where network 100 is part of the regular service provider of wireless device but where network 100 may be in another location or state that is not the main or home location of wireless device 116. In a fixed wireless arrangement, WiMAX type customer premises equipment (CPE) 122 may be located in a home or business to provide home or business customer broadband access to internet 110 via base station 120, ASN-GW 118, and home CSN/AAA 126 in a manner similar to access by wireless device 116 via base station 114, ASN-GW 112, and visited CSN/AAA 124, a difference being that WiMAX CPE 122 is generally disposed in a stationary location, although it may be moved to different locations as needed, whereas wireless device may be utilized at one or more locations if wireless device 116 is within range of base station 114 for example. In accordance with one or more embodiments, operation support system, self organizing networks (OSS (SON)) sever 136 may be part of network 100 to provide management functions for network 100 and to provide interfaces between functional entities of network 100. Network 100 of FIG. 1 is merely one type of wireless network showing a certain number of the components of network 100, however the scope of the claimed subject matter is not limited in these respects.

In some embodiments, wireless device 116 may couple to network 100 via a wireless communication link with one or more relay stations (RS) 128 rather than a wireless communication link with base station 114. As shown in FIG. 1, relay station 128 comprises a lower power base station device designed to enhance the coverage area for wireless devices 116 serviced by network 100. In some embodiments relay station 128 may be located at or near the edge, or outside of the coverage are of one or more base stations 114 and/or base stations 120 of network 100. Alternatively, relay station 128 may increase performance of wireless devices located within buildings that may attenuate or otherwise interfere with wireless communications with base station 114.

Referring now to FIG. 1B, in some embodiments the network 100 may be organized as a cellular network comprising a number of cells 170. Each cell 170 may be serviced by a base station 114 which may be disposed approximately in the center of the cell 170. In some embodiments the cell may be subdivided into sectors, designated S1, S2, and S3 in FIG. 1B. Typically, each sector covers a 120 degree angle of the cell 170. Various frequency allocation schemes may be implemented by the base stations 114 to reduce interference between adjacent cells 170. By way of example, cellular networks 100 may implement various frequency reuse schemes to reduce interference between adjacent cells.

A region surrounding the base station 114 may be described as the cell center 172. In practice, the region defined as the cell center 172 may be defined by signal strength characteristics rather than geographic boundaries. For example, the cell center 172 may be defined as the geographic region in which the signal strength of the signal from the base station 114 exceeds a minimum threshold. The strength of a signal from the base station 114 decays as the distance from the base station 114 increases. Thus, in practice the border defining the cell center 172 may expand or contract based on factors such as the transmission power implemented by the base station 114 at any particular point in time, geographic features, or physical obstacles in the communication path between a wireless device 116 and the base station 114. In addition, while the border defining the cell center 172 is depicted as a circle having a defined radius, one skilled in the art will recognize that the cell center may not be a uniform circle. Rather, the border may deviate as a function of transmission power, geographic features, physical obstacles, and the like.

The region outside the cell center 172 may be referred to as a cell edge 174. Again, the cell edge 174 may be defined by signal strength characteristics rather than geographic characteristics. For example, the cell edge 174 may be defined by the geographic region in which the signal strength of the signal from the base station 114 is below a threshold. A cell-edge may also be defined if signal-to-interference-plus-noise ratio is below a threshold. The SINR metric not only measures signal strength, but also interference levels at cell-edge (which can be quite high). When cell-edge is defined as users with SINR below a certain threshold, cell-center users are the remaining user associated with that BS.

One or more relay stations 128 may be positioned in the cells 170. As described above, a relay station 128 may be positioned in an environment in which the signal from the base station 114 is degraded due to the environment (e.g., obstacles such as a building) or due to the distance from the base station 114 a wireless device 116 is located. For example, relay stations 128 may be located near the edge of a network cell 170 to bolster service quality of wireless devices 116 operating in a cell edge 174.

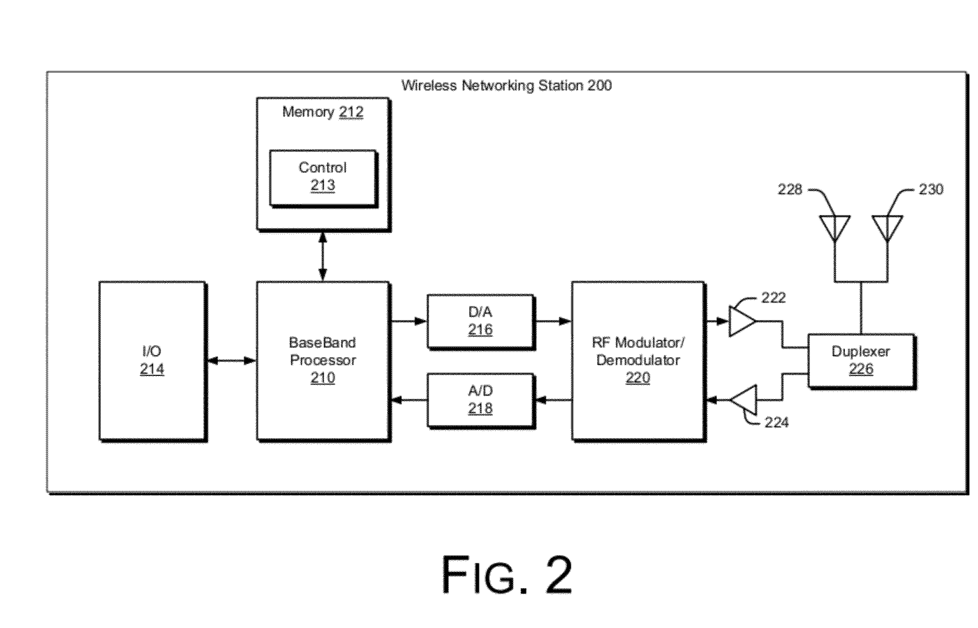

Referring now to FIG. 2, a block diagram of a wireless network station 200 in accordance with one or more embodiments will be discussed. FIG. 2 illustrates an example block diagram of wireless network station 200 which may be either a base station 112 or a relay station 128 as shown in and described with respect to FIG. 1, above. FIG. 2 depicts the major elements of an example wireless network station 200, however fewer or additional elements may be included in alternative embodiments in addition to various other elements that are not shown herein, and the scope of the claimed subject matter is not limited in these respects. Wireless network station 200 may comprise a baseband processor 210 coupled to memory 212 for performing the control functions of wireless network station 200. Input/output (I/O) block 214 may comprise various circuits for coupling wireless network station 200 to one or more other devices. For example, I/O block 214 may include one or more Ethernet ports and/or one or more universal serial bus (USB) ports for coupling relay station 128 to modem 130 or other devices. For wireless communication, relay station 128 may further include a radio-frequency (RF) modulator/demodulator for modulating signals to be transmitted and/or for demodulating signals received via a wireless communication link. A digital-to-analog (D/A) converter 216 may convert digital signals from baseband processor 210 to analog signals for modulation and broadcasting by RF modulator/demodulator via analog and/or digital RF transmission techniques. Likewise, analog-to-digital (A/D) converter 218 may convert analog signals received and demodulated by RF modulator/demodulator 220 digital signals in a format capable of being handled by baseband processor 210. Power amplifier (PA) 222 transmits outgoing signals via one or more antennas 228 and/or 230, and low noise amplifier (LNA) 224 receives one or more incoming signals via antennas 228 and/or 230, which may be coupled via duplexer 226 to control such bidirectional communication. In one or more embodiments, wireless network station 200 may implement single input, single output (SISO) type communication, and in one or more alternative embodiments wireless network station 200 may implement multiple input, multiple output (MIMO) communications, although the scope of the claimed subject matter is not limited in these respects.

Referring back to FIG. 1, in some embodiments a relay station 128 and base station 114 may implement communication protocols to facilitate wireless communication therebetween. In such embodiments a control module 213 may implement communication operations in accordance with the description provided herein. In some embodiments the control module 213 may be implemented as logic instructions stored in the computer readable medium of memory 212. When executed by a processor, e.g., the baseband processor 210 or another processor in or coupled to access point 128, the control module may implement one or more operations to manage interference between a relay station 128 and a base station 114, or between a relay station and a neighboring relay station.

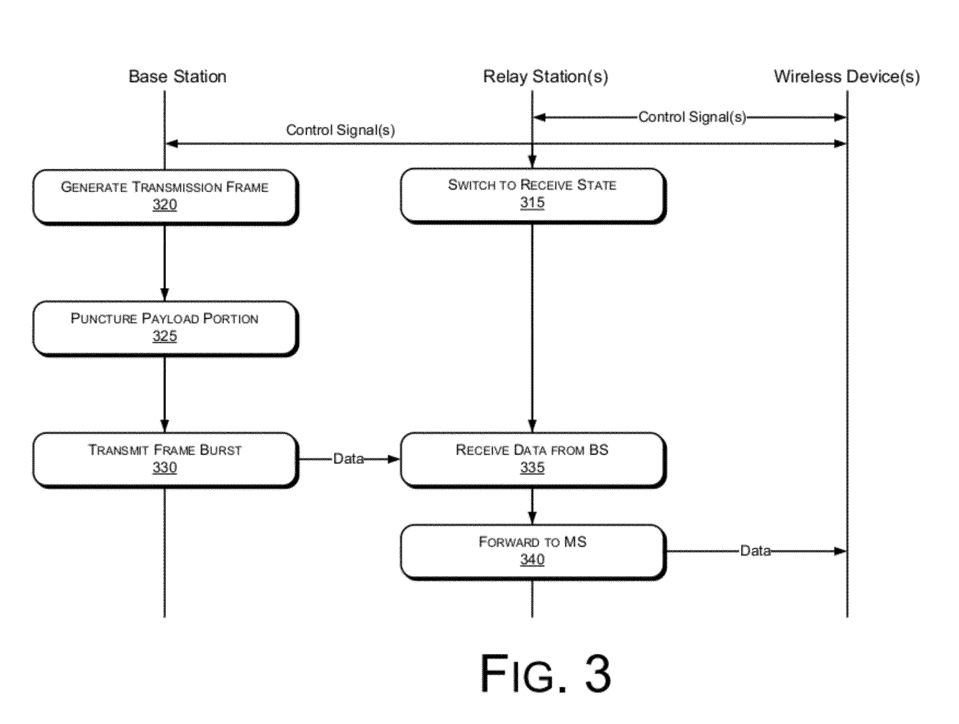

Techniques to manage communication between a base station 114 and relay station 128 will be explained with reference to FIG. 3 and FIG. 4. In some embodiments communication between the base station 114 and the relay station may be referred to as “downlink” communication. In accordance with the description provided herein, a base station 114 implements a physical layer protocol in which payload signals are delayed by at least one OFDM symbol in the payload section of a data burst frame. Implementing this delay provides the relay station 128 with adequate time to transition into a receive state in order to receive the data burst frame.

FIG. 4 is a schematic illustration of a frame structure suitable for use in communication between a base station and a relay station, according to embodiments. Referring briefly to FIG. 4, a transmission burst subframe 400 is transmitted in a plurality of orthogonal frequency division multiplexing (OFDM) symbols, which are represented as columns in FIG. 4. The burst subframe 400 comprises control signaling, represented by the A-MAP message 410 and may comprise a plurality of transmissions to different receivers. In the embodiment depicted in FIG. 4 the burst subframe 400 includes a transmission block 420 to a first wireless device and a transmission block 450 to a second wireless device. Subframe 400 further comprises a payload transmission block 430 to a relay station. The subframe 400 may carry one or more pilot symbols 440.

Referring to FIGS. 3 and 4, in downlink communication the base station 114 and the relay station 128 exchange control signaling such as preambles, midambles, and superframe headers with one or more wireless devices 116 serviced by the base station 114 and/or the relay station 128. Once the downlink control signals are transmitted, the relay station 128 may switch (operation 315) from a transmit state into a receive state to receive the data from the base station 114. The state transition of the relay station 128 starts with the beginning of the first subframe 400 and should occur within a time frame corresponding to a one OFDM symbol delay. As illustrated in FIG. 4, the base station 114 punctures (i.e., does not transmit) the data payload in the first OFDM symbol of the payload transmission block 430, as indicated by the “silence” label in block 432 of FIG. 4. Since the data payload transmission 430 is delayed by one symbol, the relay station 128 has enough time to transition to the receive state to receive (operation 335) the data correctly. The data may then be forwarded (operation 340) to the wireless device.

During relay station state transition the base station 114 generates (operation 320) a transmission frame such as the frame depicted in FIG. 4, punctures (operation 325) the payload portion and transmits (operation 330) the frame burst comprising the subframe 400. The downlink control channel signals (e.g., the A-MAP message, which may be addressed not only to the RS, but also to some wireless devices, see FIG. 1). Therefore the relay station 128 may fail to receive part of the control channel and pilot signals during the time period in which the relay station 128 is in transition. However, the control channel signals and pilot signals are typically designed with sufficient robustness to compensate for poor receive conditions in wireless devices. This extra robustness together with good channel conditions typically present on the communication link between the base station 114 and the relay station 128 allows the relay station 128 to process the control signals correctly using standard processing algorithms.

Techniques to manage communication between a relay station 128 and the base station 114 will be explained with reference to FIG. 5 and FIGS. 6-8. In some embodiments communication between the relay station 128 and the base station 114 may be referred to as “uplink” communication. In accordance with the description provided herein, a relay station 128 implements a physical layer protocol in which both payload signals and control signals are delayed by at least one symbol data burst frame. Implementing this delay provides the base station 114 with adequate time to transition into a receive state in order to receive the data burst frame.

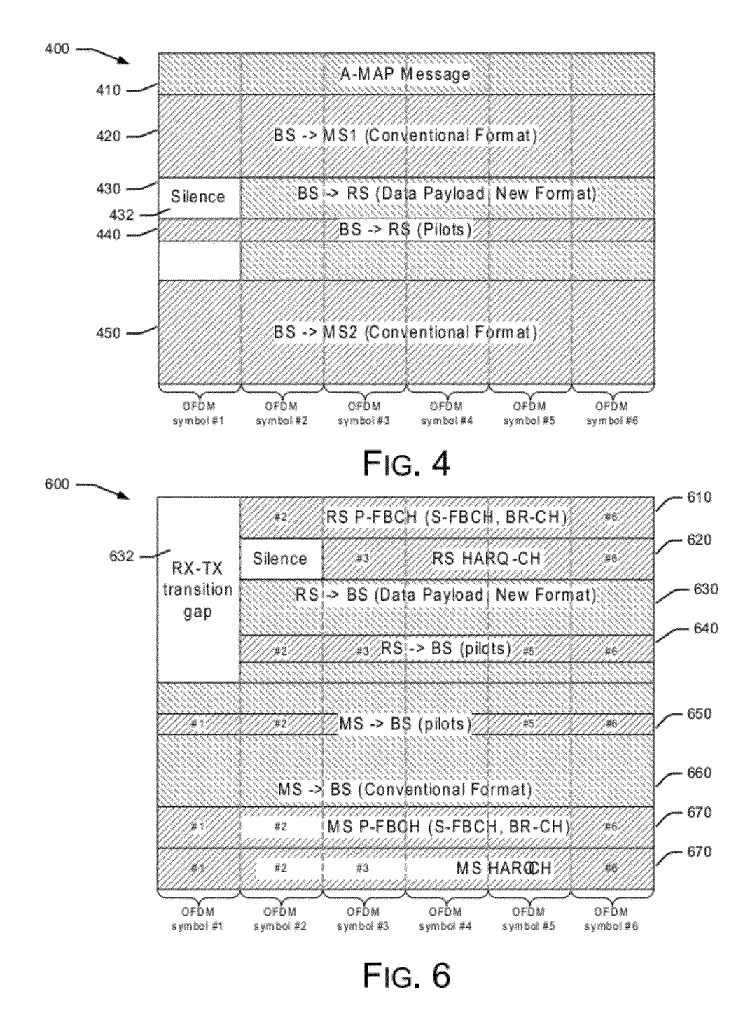

FIG. 6 is a schematic illustration of a frame structure suitable for use in communication between a base station and a relay station, according to embodiments. Referring briefly to FIG. 6, a transmission burst subframe 600 is transmitted in a plurality of orthogonal frequency division multiplexing (OFDM) symbols, which are represented as columns in FIG. 6. The burst subframe 600 comprises control signaling, represented by the relay station primary feedback channel (RS P-FBCH) the secondary feedback channel (S-FBCH) and the bandwidth request channel (BR-CH) 610 and may comprise a plurality of transmissions to different receivers. In the embodiment depicted in FIG. 6 the burst subframe 600 includes a control signaling transmission block 620 for a hybrid automatic repeat request (HARQ) to the relay station 128 and a transmission block 630 to send data payload to the base station 114. Subframe 600 further comprises transmission block 640 to send pilot signals from the relay station 128 to the base station 114. Subframe 600 further comprises a transmission block 650 for pilot symbols between the mobile station and the base station 114, a transmission block 660 for payload between the mobile station and the base station 114, and transmission blocks 670 and 680 respectively for control signaling and HARQ between the mobile station and the base station 114.

Referring to FIGS. 5 and 6-10 in uplink communication the base station 114 and the relay station 128 exchange control signaling such as preambles, midambles, and superframe headers with one or more wireless devices 116 serviced by the base station 114 and/or the relay station 128. At operation 515 the relay station 128 receives data from one or more wireless devices. Once the data is received, the relay station 128 may switch (operation 520) from a receive state into a transmit state to transmit the data to the base station 114. The state transition of the relay station 128 starts (operation 520) with the beginning of the first subframe 600 and should occur within a time frame corresponding to a one OFDM symbol delay. As illustrated in FIG. 6, the relay station 128 generates the transmission frame (at operation 525) and at operation 530 punctures (i.e., does not transmit) the control signals 610, 620, 640 and the data payload 630 in the first OFDM symbol of the payload transmission block 600, as indicated by the “RX-TX transition gap” label in block 632 of FIG. 6. Since the data payload transmission 630 is delayed by one symbol, the relay station 128 has enough time to transition to the transmit state to transmit (operation 535) the data correctly to the base station 114.

As illustrated in FIG. 6, the relay station 128 also transmits the pilot signals after the one OFDM symbol delay. However, pilot symbol transmission may start from second symbol of the pilot signal pattern. From the perspective of the base station 114, this should appear as if the relay station 128 transmitted the entire pilot sequence starting from the beginning of the subframe, but had punctured out the first OFDM symbol. Therefore to process the pilot signals the BS may use standard recovery algorithms (e.g., those used for processing MS's pilots).

The relay station may start transmission of the uplink control channel signals after a delay of either one or two OFDM symbols from the beginning of the subframe, depending on the type of the control channel, starting from the second or third OFDM symbol of the control channel sequence respectively. For the base station 114 this should appear as if the relay station 128 transmitted the entire control channel signal starting from the beginning of the subframe, but had punctured out first one or two OFDM symbols, depending on the type of the control channel signal. The uplink control channel signals, whose encoding is based on single OFDM symbols, are transmitted after a one OFDM symbol delay (e.g., P-FBCH, S-FBCH, and BR-CH 610).

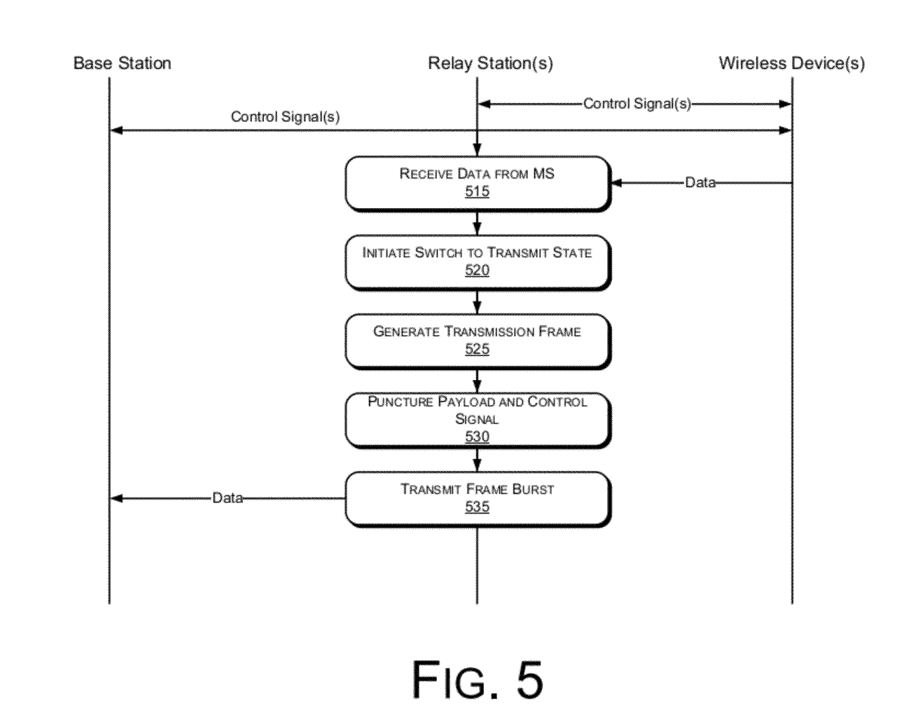

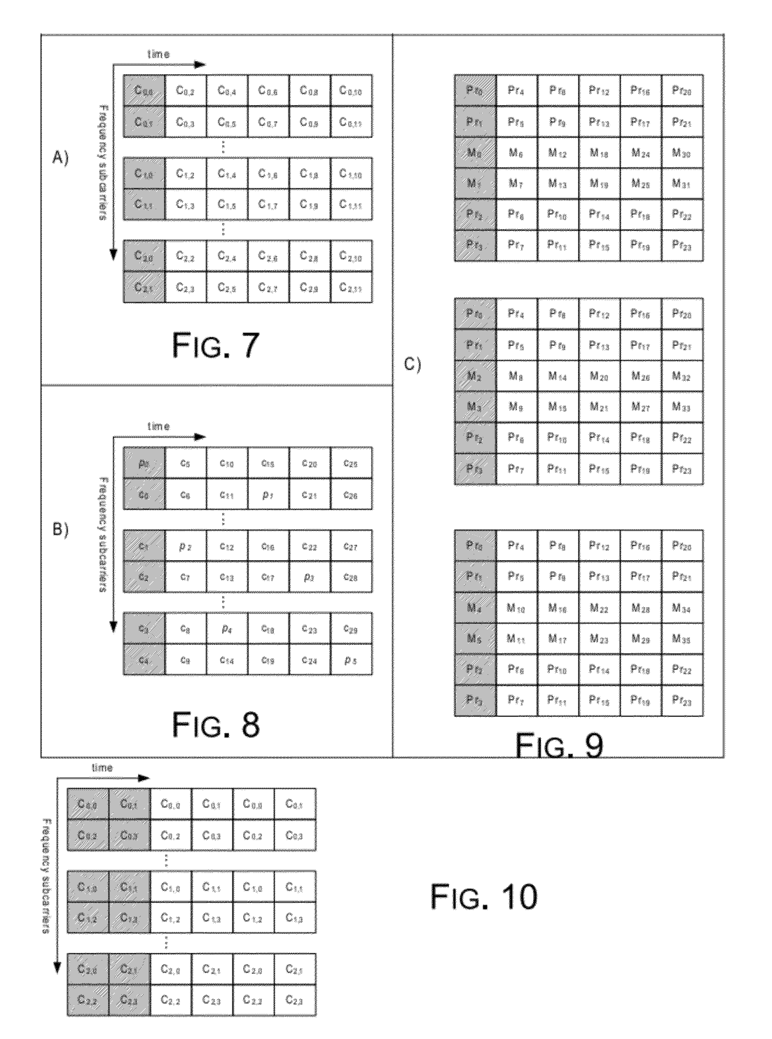

FIG. 7 is a schematic illustration of the transmission format for the uplink primary feedback channel (P-FBCH). As illustrated in FIG. 7, the first OFDM symbol is punctured, as indicated by the gray shading. FIG. 8 is a schematic illustration of the transmission format for the uplink secondary feedback channel (S-FBCH). As illustrated in FIG. 8, the first OFDM symbol is punctured, as indicated by the gray shading. Similarly, FIG. 9 is a schematic illustration of the transmission format for the uplink bandwidth request channel (BR-CH). As illustrated in FIG. 9, the first OFDM symbol is punctured, as indicated by the gray shading.

The format of certain control channels like the uplink RS HARQ-CH 620 may be based on pairs of OFDM symbols, and therefore to enable correct processing of punctured signal, first pair of OFDM symbols is punctured out entirely for such control channels. For this purpose, one more OFDM symbol of silence is inserted after the RX-TX transition gap for such channels. FIG. 10 is a schematic illustration of the transmission format for the uplink HARQ channel (HARQ-CH). As illustrated in FIG. 10, the first OFDM symbol is punctured, as indicated by the gray shading.

Thus, described herein are various network architectures, base stations, relay stations, and methods to manage communication between base stations and relay stations. While particular terminology is used herein to describe various components and methods, one skilled in the art will recognize that such terminology is intended to be descriptive and not limiting. By way of example, the term base station is intended to refer to a device which provides access to a network, and the term relay station is intended to refer to a device which provides access to a lower-level network within the network serviced by the base station. Similarly, the phrase “wireless device” is intended to refer to any type of device which can transmit or receive data on the network. It will be understood that these phrases are intended to apply to multiple different wireless networking standards and to networking standards and configurations not yet described or implemented.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

Reference in the specification to “one embodiment” or “an embodiment” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A base station, comprising:
a baseband processor;
an RF modulator/demodulator coupled to the baseband processor to modulate/demodulate data for communication within a predetermined frequency range; and
a control module to:
generate a transmission burst for transmission from the base station to the relay station, the transmission burst comprising:
a control signal portion; and
a payload portion; and
implement a transmission delay of at least one symbol in transmitting the payload portion.

2. The base station of claim 1, wherein the control module:
transmits one or more downlink control signals from the base station to the relay station and one or more wireless devices which are being serviced by the base station.

3. The base station of claim 1, wherein the relay station transitions from a transmit state to a receive state during a time period corresponding to the transmission delay of at least one symbol.

4. The base station of claim 3, wherein the base station transmits control channel signals while the relay station transitions to a receive state.

5. The base station of claim 4, wherein the base station transmits control channel signals to the relay station and to one or more wireless devices.

6. A method to manage data transmission between a relay station and a base station in a wireless communication network, comprising:
generating a transmission burst for transmission from the relay station to the base station, the transmission burst comprising:
a control signal portion; and
a payload portion; and
puncturing the control signal portion and the payload portion.

7. The method of claim 6, wherein the relay station transitions from a receive state to a transmit state during a time period corresponding to the transmission delay of at least one symbol.

8. The method of claim 7, wherein the relay station receives a data transmission from a wireless device prior to generating a transmission burst for transmission from the relay station to the base station.

9. The method of claim 8, wherein the relay station delays transmission of a control channel signals by at least two symbols.

10. The method of claim 6, wherein puncturing the control signal portion and the payload portion comprises implementing a transmission delay of at least one symbol in transmitting the control signal and the payload portion.

11. A relay station, comprising:
a baseband processor;
an RF modulator/demodulator coupled to the baseband processor to modulate/demodulate data for communication within a predetermined frequency range; and
a control module to generate a transmission burst for transmission from the relay station to the base station, the transmission burst comprising:
a control signal portion; and
a payload portion; and
implementing a transmission delay of at least one symbol in transmitting the control signal portion and the payload portion.

12. The relay station of claim 11, wherein the relay station transitions from a receive state to a transmit state during a time period corresponding to the transmission delay of at least one symbol.

13. The relay station of claim 12, wherein the relay station receives a data transmission from a wireless device prior to generating a transmission burst for transmission from the relay station to the base station.

14. The relay station of claim 11, wherein the relay station delays transmission of a control channel signals by at least two symbols.

15. A method to manage data transmission between a first station and a second station, comprising:
generating a transmission burst for transmission from the first station to the second station, the transmission burst comprising:
a control signal portion; and
a payload portion; and
puncturing at least one of the control signal portion and the payload portion.

16. The method of claim 15, wherein puncturing at least one of the control signal portion and the payload portion comprises implementing a transmission delay of at least one symbol in transmitting the payload portion.

17. The method of claim 15, comprising:
transmitting one or more control signals between the first station and the second station.

18. The method of claim 15, wherein at least one of the first station or the second station transitions from a transmit state to a receive state during a time period corresponding to the transmission delay of at least one symbol.

19. The method of claim 18, wherein at least one of the first station or the second station transmits control channel signals while the other station transitions to a receive state.
